(19) United States
(12) Patent Application Publication
(10) Pub. No.: US 2017/0278195 A1
(43) Pub. Date: Sep. 28, 2017

(54) BIOMETRIC DATA RECORDING METHOD AND BIOMETRIC DATA RECORDING DEVICE

(71) Applicant: FUJITSU LIMITED, Kawasaki-shi (JP)

(72) Inventor: Suguru Washio, Yokohama (JP)

(73) Assignee: FUJITSU LIMITED, Kawasaki-shi (JP)

(21) Appl. No.: 15/433,599

(22) Filed: Feb. 15, 2017

(30) Foreign Application Priority Data
Mar. 28, 2016 (JP) 2016-064600

(51) Int. Cl. G06Q 40/08; G06F 21/32

(52) U.S. Cl. CPC G06Q 40/08; G06F 21/32

(57) ABSTRACT

A computer obtains time-series biometric data detected by a sensor, refers to a memory storing reference data in association with a subject and determines whether or not a part of the obtained biometric data corresponds to the reference data. The computer records the obtained biometric data in association with the subject that is associated with the reference data when the part of the obtained biometric data corresponds to the reference data.

### CROSS-REFERENCE TO RELATED APPLICATION

This application is based upon and claims the benefit of priority of the prior Japanese Patent Application No. 2016-064600, filed on Mar. 28, 2016, the entire contents of which are incorporated herein by reference.

### FIELD

The embodiments discussed herein are related to a biometric data recording method and a biometric data recording device.

### BACKGROUND

In recent years, insurance in which insurance fees are calculated on the basis of the characteristics or grades of individual persons such as telematics insurance has emerged and been spreading. For example, automobile insurance etc. in which a device measures the smoothness of starting to move, acceleration, right or left turn, stopping moving, etc. during driving of an automobile so as to calculate a driving grade so that the insurance fee is discounted has emerged.

A wearable device that conducts biometric authentication by obtaining the biometric information from the user and a system that obtains health management information together with personal authentication are also known (see Patent Documents 1 and 2 for example). Biometric authentication using an electrocardiogram, a palm vein, etc., and personal authentication using position information are also known (see Non-Patent Documents 1 through 4).

Patent Document 1: Japanese Laid-open Patent Publication No. 2008-198028

Patent Document 2: Japanese Laid-open Patent Publication No. 2007-202869

Non-Patent Document 1: “BIOMETRIC HUMAN IDENTIFICATION BASED ON ECG”, [online], [searched on Mar. 10, 2016], Internet <URL:http://www.physionet.org/pn3/ecgiddb/biometric.shtml>

Non-Patent Document 2: Israel et al . , “ECG to identify individuals”, Pattern Recognition, Volume 38, Issue 1, January 2005, pp.133-142

Non-Patent Document 3: “palm vein authentication principle-matching”, [online], [searched on Mar. 10, 2016], Internet <URL:http://www.fujitsu.com/jp/group/labs/resources/tech/te chguide/list/vein/p05.html>

Non-Patent Document 4: Zhang et al., “Location-based Authentication and Authorization Using Smart Phones”, Trust, Security and Privacy in Computing and Communications (TrustCom), 2012 IEEE 11th International Conference on Trust, Security and Privacy in Computing and Communications, June 2012, pp. 1285-1292

### SUMMARY

According to an aspect of the embodiments, a computer performs the following process.

(1) The computer obtains time-series biometric data detected by a sensor.

(2) The computer refers to a memory storing reference data in association with a subject and determines whether or not a part of the obtained biometric data corresponds to the reference data stored in the memory.

(3) The computer records the obtained biometric data in association with the subject that is associated with the reference data when the part of the obtained biometric data is determined to correspond to the reference data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates impersonation;

FIG. 2 illustrates biometric authentication using biometric data in case of a poor physical condition;

FIG. 3 illustrates alternative authentication;

FIG. 4 illustrates a functional configuration of a biometric data recording device;

FIG. 5 is a flowchart illustrating a biometric data recording process;

FIG. 6 is a functional configuration diagram illustrating a first specific example of the biometric data recording device;

FIG. 7 illustrates a biometric data recording process that prevents impersonation;

FIG. 8 illustrates a biometric data recording process of recording biometric data based on a poor physical condition;

FIG. 9 illustrates auxiliary authentication;

FIG. 10 illustrates setting information;

FIG. 11 illustrates reference data and reference auxiliary data;

FIG. 12 illustrates reception information;

FIG. 13 illustrates result information;

FIG. 14 is a flowchart illustrating a specific example of a biometric data recording process;

FIG. 15A is a flowchart of an authentication process (first part);

FIG. 15B is a flowchart of the authentication process (second part);

FIG. 16A and FIG. 16B illustrate reception information and result information, respectively, in an initial state;

FIG. 17A and FIG. 17B illustrate reception information and result information, respectively, when electrocardiogram data is transmitted;

FIG. 18A and FIG. 18B illustrate reception information and result information, respectively, when next electrocardiogram data is transmitted;

FIG. 19 illustrates reception information and result information when authentication succeeds;

FIG. 20 illustrates result information in which an entry has been deleted;

FIG. 21 illustrates biometric data stored in a different storage unit;

FIG. 22 is a functional configuration diagram illustrating a second specific example of the biometric data recording device; and

FIG. 23 illustrates a configuration of an information processing apparatus.

### DESCRIPTION OF EMBODIMENTS

Hereinafter, detailed explanations will be given for the embodiments by referring to the drawings.

Accompanying the trend of the above telematics insurance, life insurance in which health data is measured by using a wearable device etc. so as to reflect the health condition or attitude toward exercise on the insurance fee etc. may emerge. As health data, for example time-series biometric data such as electrocardiogram data, which represents the heart rate, pulse wave data, which represents the pulse, etc. can be used.

Also, Japan Revitalization Strategy, proposed by the government, has caused a stronger demand that companies make efforts to manage the health maintenance of their employees. This leads to a possibility that companies will take measures in which incentive is given in return for health maintenance of their employees and that a wearable device etc. will be used for making efforts at health maintenance of their employees or for managing their health conditions.

However, a subject may register different person's biometric data as the subject's biometric data when biometric data representing the health condition and the subject are to be registered in an associated manner.

This problem may occur also in a case when biometric data other than electrocardiogram data or pulse wave data is registered.

When health data is used for determining the insurance fee of life insurance, the health maintenance of an employee, etc., there is a possibility that impersonation occurs in which the user of a wearable device, aiming at an advantageous result, has the device worn by a different healthy person purposefully so that the health data of that healthy person is measured.

Conventionally, the user has first conducted personal authentication and then the user's health data has been picked up in order for the user to confirm his or her health condition. In other words, the user has conducted personal authentication in order to protect the user's health data. This means that the user does not have a motive for having different person's health data measured for him or her, and no countermeasures against impersonation have been prepared.

However, when other people such as an insurance company, an employer, etc. use health data, there is a possibility that the user will conduct impersonation for his or her benefit. This increases the importance of techniques that guarantee that health data picked up by a wearable device really belongs to the true subject.

When health data is picked up after conducting personal authentication, it is also possible for the subject to input his or her password etc. after making a different person wear the wearable device so as to have the different person's health data picked up as has been conducted conventionally. Therefore, just conducting authentication, using ID, password, integrated circuit (IC) chip, fingerprint, etc., based on the intention of the subject when the subject puts on a wearable device does not guarantee that the picked-up data is heath data belonging to the subject.

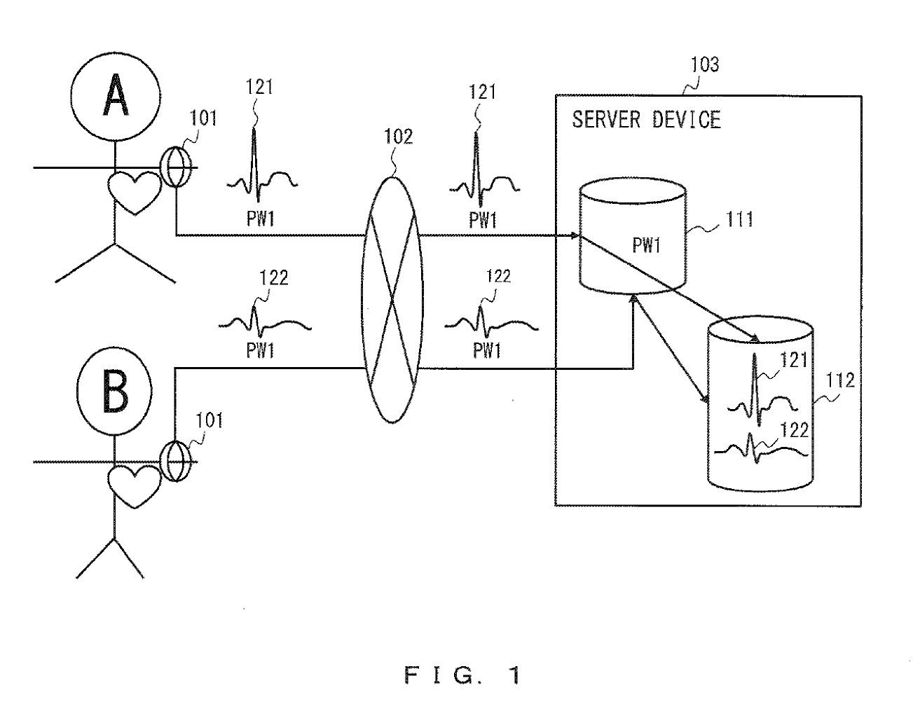

FIG. 1 illustrates an example of impersonation as described above. A server device 103 includes a password storage unit 111 and a biometric data storage unit 112, and the password storage unit 111 stores password PW1 of user A. A wearable device 101 communicates with the server device 103 via a communication network 102.

First, user A puts on the wearable device 101 and inputs the user ID and password PW1 to the wearable device 101. The wearable device 101 picks up electrocardiogram data 121 of user A, and transmits the electrocardiogram data 121, the user ID and password PW1 to the server device 103.

The server device 103 compares password PW1 received from the wearable device 101 with password PW1 of user A that is stored in the password storage unit 111, and determines the authentication to be success because they are identical. Then, the server device 103 records the electrocardiogram data 121 received from the wearable device 101 in the biometric data storage unit 112 and as the electrocardiogram data of user A.

Next, user A has the wearable device 101 worn by user B, and tells him or her the user ID and password PW1 so as to ask him or her to register the biometric data. User B inputs the user ID and password PW1 of user A to the wearable device 101, and the wearable device 101 picks up electrocardiogram data 122 of user B so as to transmit the electrocardiogram data 122, the user ID and password PW1 to the server device 103.

The server device 103 compares password PW1 received from the wearable device 101 with password PW1 of user A that is stored in the password storage unit 111, and determines the authentication to be success because they are identical. Then, the server device 103 records the electrocardiogram data 122 received from the wearable device 101 in the biometric data storage unit 112 and as the electrocardiogram data of user A.

As described above, when user A tells user B his or her user ID and password, it is possible to register user B's biometric data as user A's biometric data regardless of when the authentication is conducted.

Also, even when biometric authentication based on biometric data is conducted instead of personal authentication based on password, different person's biometric data can be registered as the subject's biometric data by the subject conducting the biometric authentication by himself or herself and thereafter picking up the biometric data of that different person.

Methods may be possible in which identity confirmation is conducted periodically or putting off of the wearable device is detected so as to conduct reauthentication when the device is put on in order to prevent impersonation as described above. However, in cases of biometric authentication such as fingerprint authentication etc., a high frequency of reauthentication deteriorates convenience of users while low frequency of authentication allows impersonation in a period between biometric authentication and the next biometric authentication. Therefore, it is difficult to securely prevent impersonation by reauthentication.

Also, the accuracy of biometric information greatly depends upon the measurement accuracy of the wearable device, leading to a situation where biometric data is not picked up correctly, making the authentication fail due to an inappropriate manner of wearing the wearable device. Further, depending upon the state, the physical condition, etc. of the wearing person, there may be a case where characteristics that are adequate for authentication are not extracted from picked-up biometric data, making the authentication fail.

Even in an environment where biometric authentication can easily fail as described above, repeated and many times of biometric authentication may result in success of authentication. However, when biometric data starts to be recorded after success of authentication, biometric data between the start and success of the authentication is not recorded.

In conventional biometric authentication, biometric information, such as vein, fingerprint, etc., that is not easily influenced by the state, the physical condition, etc. of the wearing person has often been used and thus cases where authentication does not succeed immediately such as in a case of biometric authentication using electrocardiogram data is not supposed. Thus, picking up and recording of biometric data after success of authentication is believed to cause no problem, and biometric data before success of authentication is not recorded. Accordingly, even when important information is contained in biometric data before success of authentication, that piece of biometric data is discarded.

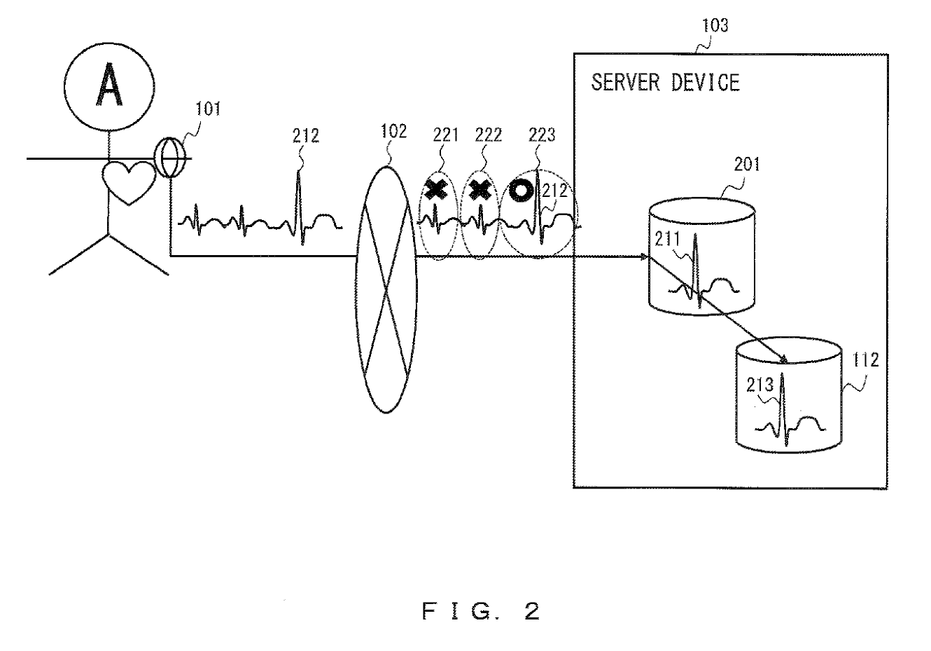

FIG. 2 illustrates an example of biometric authentication using biometric data in case of a poor physical condition. The server device 103 includes a reference data storage unit 201, and the reference data storage unit 201 stores the electrocardiogram data of user A as reference data 211 for biometric authentication. The wearable device 101 picks up the electrocardiogram data 212 of user Aso as to transmit the data to the server device 103. The server device 103 compares the electrocardiogram data 212 received from the wearable device 101 with the reference data 211 of user A stored in the reference data storage unit 201.

In the electrocardiogram data 212, the data portions of past periods 221 and 222 represent the electrocardiograms when the user A is in a poor physical condition, while the data portion of a current period 223 represents the electrocardiogram when the physical condition of user A has recovered. In such a case, the data portions of the periods 221 and 222 are not identical with the reference data 211 so that the authentication is determined to be failure, and these data portions are discarded. Then, biometric authentication is repeated until the authentication succeeds.

Thereafter, upon reception of the data portion of the period 223, the server device 103 determines the authentication to be success because that data portion is identical with the reference data 211. Then, the server device 103 records the data portion of the period 223 in the biometric data storage unit 112 as electrocardiogram data 213 of user A.

As described above, authentication fails in a case when the subject is in a poor physical condition, when the authentication is conducted immediately after intense exercise or in other cases, and thereby biometric data in which a health condition based on a poor physical condition etc. is reflected is prevented from being recorded. In view of this, it may also be possible to conduct alternative authentication by using alternative data, which is different from biometric data, when biometric authentication fails repeatedly.

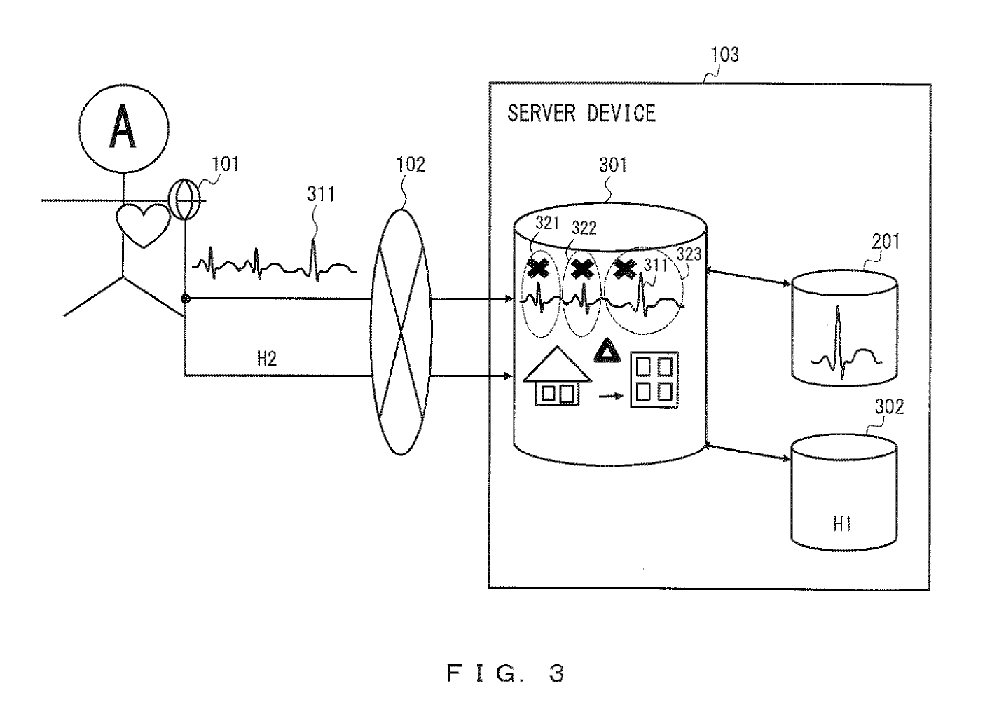

FIG. 3 illustrates alternative authentication. The server device 103 includes a registration data storage unit 301 and an alternative-data storage unit 302. The alternative-data storage unit 302 stores movement history H1 of user A as alternative data. Movement history H1 may be information representing for example a commutation route etc. from block AAA of city AA to block BBB of city BB. Movement history H1 representing a commutation route contains position data of the home, a transit point and the commutation destination.

The wearable device 101 picks up electrocardiogram data 311 of user A and detects movement history H2 of user A so as to transmit the electrocardiogram data 311 and movement history H2 to the server device 103. The server device 103 registers the electrocardiogram data 311 and movement history H2 received from the wearable device 101 in the registration data storage unit 301 as registration data of user A so as to compare the electrocardiogram data 311 with the reference data 211 of user A.

In the electrocardiogram data 311, the data portions of past periods 321 and 322 represent the electrocardiograms when the user A is in a poor physical condition, while the data portion of a current period 323 represents the electrocardiogram when the physical condition of user A has recovered. In this case, none of the data portions of the periods 321 through 323 is identical with the reference data 211 and thus the authentication is determined to be failure.

Then, the server device 103 switches to alternative authentication from biometric authentication so as to compare movement history H2 with movement history H1 of user A stored in the alternative-data storage unit 302. When movement history H2 corresponds to movement history H1, the server device 103 determines the authentication to be success.

Switching to alternative authentication in case of repeated failures of biometric authentication can prevent deterioration of convenience of users that would be caused by repeated reauthentication. However, it can be thought that alternative authentication using movement histories etc. makes the authentication accuracy lower than biometric authentication, making it easier to conduct impersonation by falsifying alternative data.

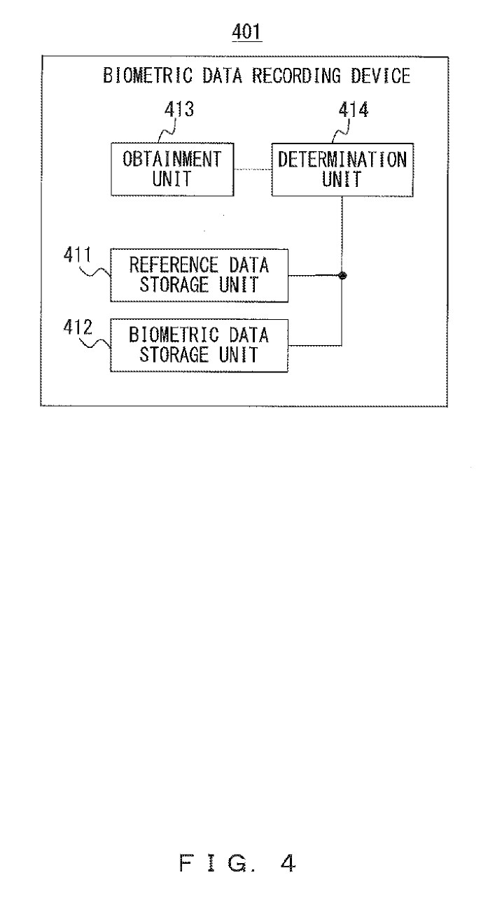

FIG. 4 illustrates a functional configuration example of a biometric data recording device according to an embodiment. A biometric data recording device 401 illustrated in FIG. 4 includes a reference data storage unit 411, a biometric data storage unit 412, an obtainment unit 413 and a determination unit 414. The reference data storage unit 411 stores reference data in association with a subject. The biometric data storage unit 412 stores biometric data in association with the subject.

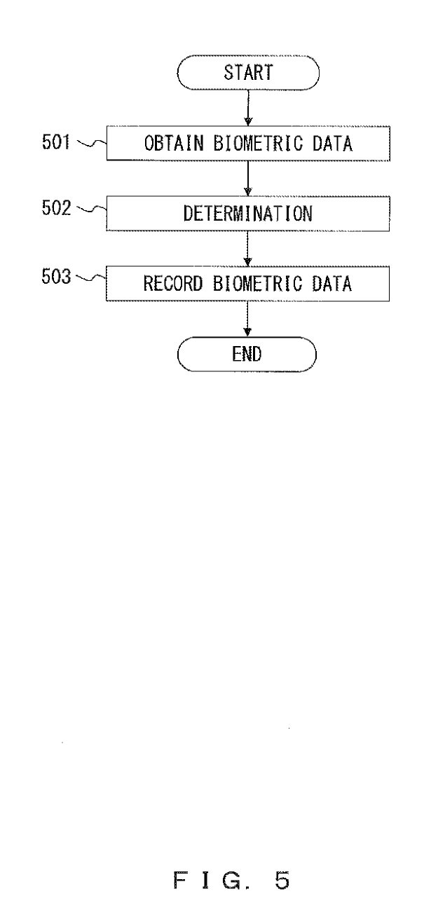

FIG. 5 illustrates a flowchart illustrating an example of a biometric data recording process performed by the biometric data recording device 401 illustrated in FIG. 4. First, the obtainment unit 413 obtains time-series biometric data detected by a sensor (step 501).

Next, the determination unit 414 refers to the reference data storage unit 411 so as to determine whether or not apart of the biometric data obtained by the obtainment unit 413 corresponds to reference data stored in the reference data storage unit 411 (step 502). When the part of the biometric data is determined to correspond to the reference data, the determination unit 414 records the obtained biometric data in the biometric data storage unit 412 in association with the subject who is associated with the reference data (step 503).

The biometric data recording device 401 as described above can prevent a situation where the biometric data of a person who is not the subject is recorded when the biometric data of the subject is to be recorded.

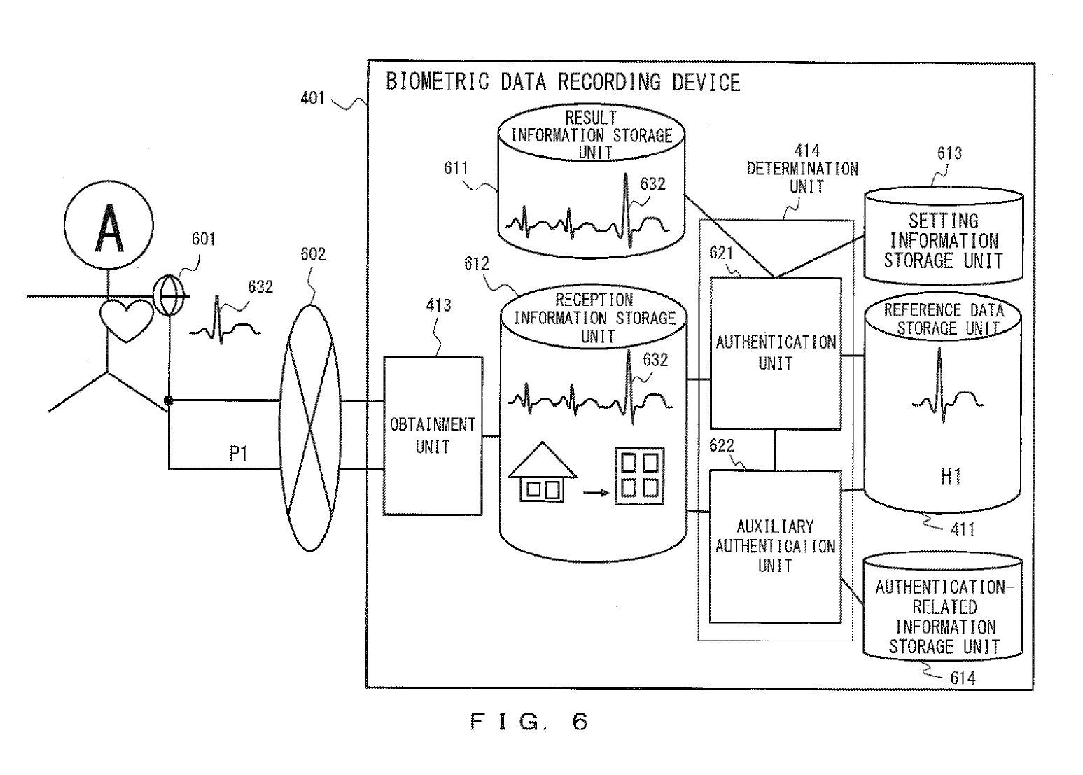

FIG. 6 illustrates a first specific example of the biometric data recording device 401 illustrated in FIG. 4. The biometric data recording device 401 illustrated in FIG. 6 includes the reference data storage unit 411, the obtainment unit 413, the determination unit 414, a result information storage unit 611, a reception information storage unit 612, a setting information storage unit 613 and an authentication-related information storage unit 614. The determination unit 414 includes an authentication unit 621 and an auxiliary authentication unit 622.

The result information storage unit 611 corresponds to the biometric data storage unit 412 illustrated in FIG. 4. User A corresponds to the subject, and the wearable device 601 worn by user A communicates with the biometric data recording device 401 via a communication network 602.

The reference data storage unit 411 stores the electrocardiogram data of user A as reference data 631 in association with user A, and stores movement history H1 of user A as reference auxiliary data in association with user A. The setting information storage unit 613 stores the parameter of a biometric data recording process as setting information, and the authentication-related information storage unit 614 stores map information used in auxiliary authentication as authentication-related information. The reception information storage unit 612 stores information received by the biometric data recording device 401 from the communication network 602. The result information storage unit 611 stores, in association with user A, the authentication result of an authentication process performed by the determination unit 414.

The wearable device 601 includes an electrocardiogram sensor and an auxiliary sensor. As the auxiliary sensor, a position sensor such as for example a Global Positioning System (GPS) receiver etc. can be used. The electrocardiogram sensor detects electrocardiogram data 632 of user A, and the position sensor detects position data P1 of user A. The wearable device 601 transmits the electrocardiogram data 632 to the biometric data recording device 401, and transmits the position data P1 to the biometric data recording device 401 as auxiliary data.

The obtainment unit 413 in the biometric data recording device 401 receives the electrocardiogram data 632 and the position data P1 from the wearable device 601 so as to record them in the reception information storage unit 612. The determination unit 414 performs an authentication process in accordance with setting information stored in the setting information storage unit 613.

The authentication unit 621 compares the electrocardiogram data 632 with the reference data 631 stored in the reference data storage unit 411 so as to conduct biometric authentication, and, when an authentication result meeting a prescribed condition has been obtained, calls the auxiliary authentication unit 622. The auxiliary authentication unit 622 uses map information stored in the authentication-related information storage unit 614 so as to compare the position data P1 and movement history H1 stored in the reference data storage unit 411, and thereby conduct auxiliary authentication.

On the basis of the results of the biometric authentication and the auxiliary authentication, the authentication unit 621 determines whether or not the data portion of some of the periods in the electrocardiogram data 632 corresponds to the reference data 631. When a data portion in the electrocardiogram data 632 corresponds to the reference data 631, the authentication unit 621 records the electrocardiogram data 632 in the result information storage unit 611 in association with user A, and records an authentication result representing success of authentication.

The authentication unit 621 may repeat an authentication process until the authentication succeeds, and may discard received electrocardiogram data 632 and position data P1 when authentication has not succeeded before user A takes off the wearable device 601.

According to the biometric data recording device 401 illustrated in FIG. 6, biometric authentication is conducted using the electrocardiogram data 632 after the electrocardiogram data 632 transmitted from the wearable device 601 is recorded in the reception information storage unit 612. In other words, biometric data is picked up first and biometric authentication is conducted by using the picked-up biometric data itself instead of picking up biometric data after success of biometric authentication as the conventional techniques do. This prevents an impersonation case in which biometric data of a different person is registered as the biometric data of the subject, and guarantees that the picked-up biometric data is data of the subject.

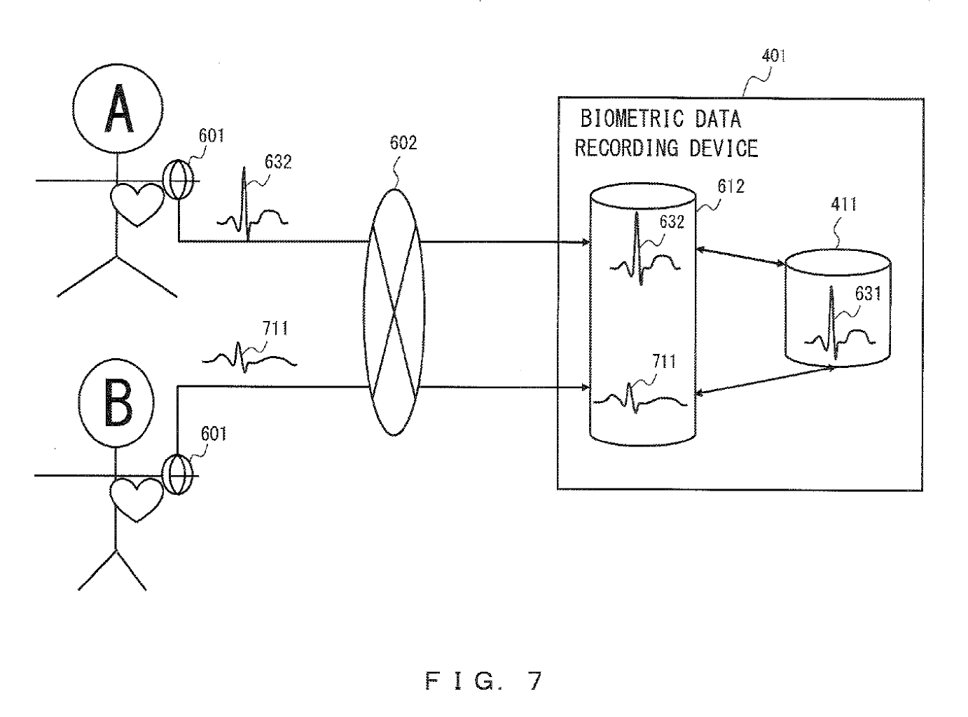

FIG. 7 illustrates an example of a biometric data recording process that prevents impersonation. The wearable device 601 picks up the electrocardiogram data 632 of user A so as to transmit the data to the biometric data recording device 401. The biometric data recording device 401 compares the electrocardiogram data 632 received from the wearable device 601 and the reference data 631 of user A, and determines the authentication to be success because the electrocardiogram data 632 corresponds to the reference data 631. Then, the biometric data recording device 401 records the electrocardiogram data 632 in the result information storage unit 611 as the electrocardiogram data of user A.

Next, user A has the wearable device 601 worn by user B, and asks him or her to register electrocardiogram data. The wearable device 601 picks up electrocardiogram data 711 of user B so as to transmit the data to the biometric data recording device 401.

The biometric data recording device 401 compares the electrocardiogram data 711 received from the wearable device 601 with the reference data 631 of user A. However, none of the data portions of the periods in the electrocardiogram data 711 corresponds to the reference data 631, and thus the biometric data recording device 401 determines the authentication to be failure and refrains from recording the electrocardiogram data 711 as the electrocardiogram data of user A.

As described above, even when user A transmits the electrocardiogram data of user B after transmitting the electrocardiogram data of user A himself or herself so as to succeed in authentication, the electrocardiogram data of user B is not registered as the electrocardiogram data of user A.

Also, the biometric data recording device 401 continues to record received electrocardiogram data in the reception information storage unit 612 even in an environment in which biometric authentication easily fails depending upon the measurement accuracy of the wearable device 601, and the state, the physical condition, etc. of user A. Continuation of measurement of electrocardiogram data for a long period of time can improve the measurement accuracy virtually and can also make it possible to succeed in authentication after the measured data has recovered from a temporary abnormal value due to a poor physical condition etc. In other words, an authentication process can be terminated when the authentication succeeds after a repeated process of comparing each period in received electrocardiogram data with a reference data.

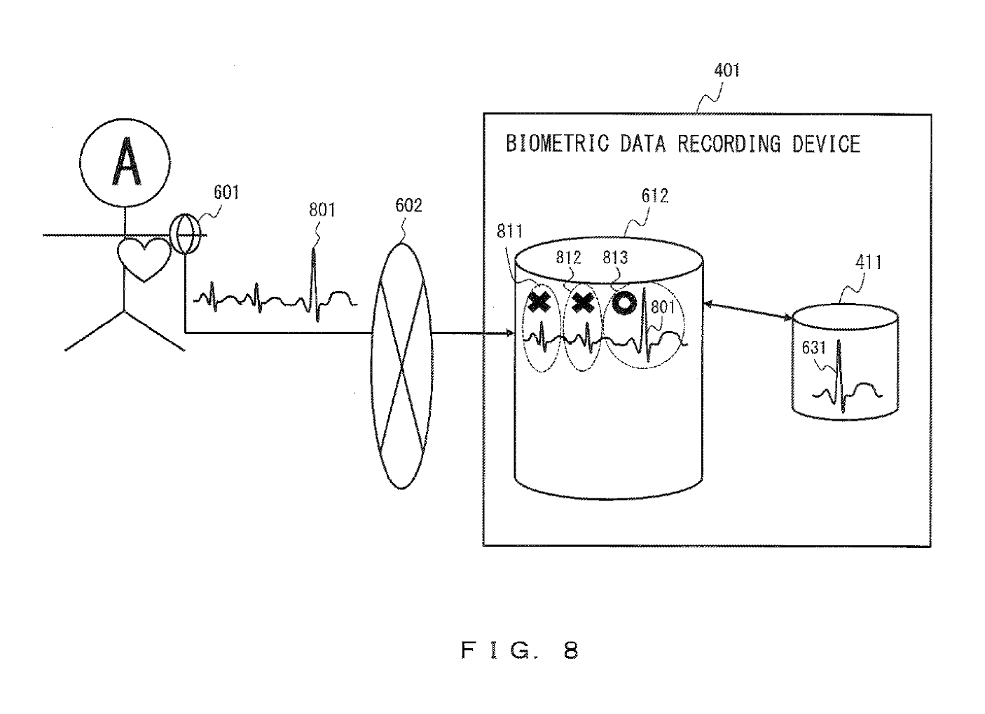

FIG. 8 illustrates an example of a biometric data recording process of recording biometric data based on a poor physical condition. The wearable device 601 picks up electrocardiogram data 801 of user Aso as to transmit the data to the biometric data recording device 401. The biometric data recording device 401 compares the electrocardiogram data 801 received from the wearable device 601 with the reference data 631 of user A.

In the electrocardiogram data 801, the data portions of past periods 811 and 812 represent the electrocardiograms when the user A is in a poor physical condition, while the data portion of a current period 813 represents the electrocardiogram when the physical condition of user A has recovered. In such a case, because the data portions of the periods 811 and 812 do not correspond to the reference data 631, an authentication process is repeated until the authentication succeeds.

Thereafter, when the data portion of the period 813 is received, the biometric data recording device 401 determines the authentication to be success because that data portion corresponds to the reference data 631. Then, the biometric data recording device 401 records the electrocardiogram data 801 including the data portions of the periods 811 through 813 in the result information storage unit 611 as the electrocardiogram data of user A.

As described above, by tracing back, after success of authentication, pieces of electrocardiogram data that were recorded in past so as to determine such pieces of electrocardiogram data to be ones of user A, it is possible to record all pieces of electrocardiogram data after user A put on the wearable device 601, as electrocardiogram data of user A. In other words, an abnormal value itself caused by a poor physical condition that would lead to a failure of the authentication can also be recorded reliably as electrocardiogram data of user A.

When there is a possibility that the person is the true subject notwithstanding a failure of authentication, the biometric data recording device 401 uses auxiliary data received from the wearable device 601 so as to conduct auxiliary authentication.

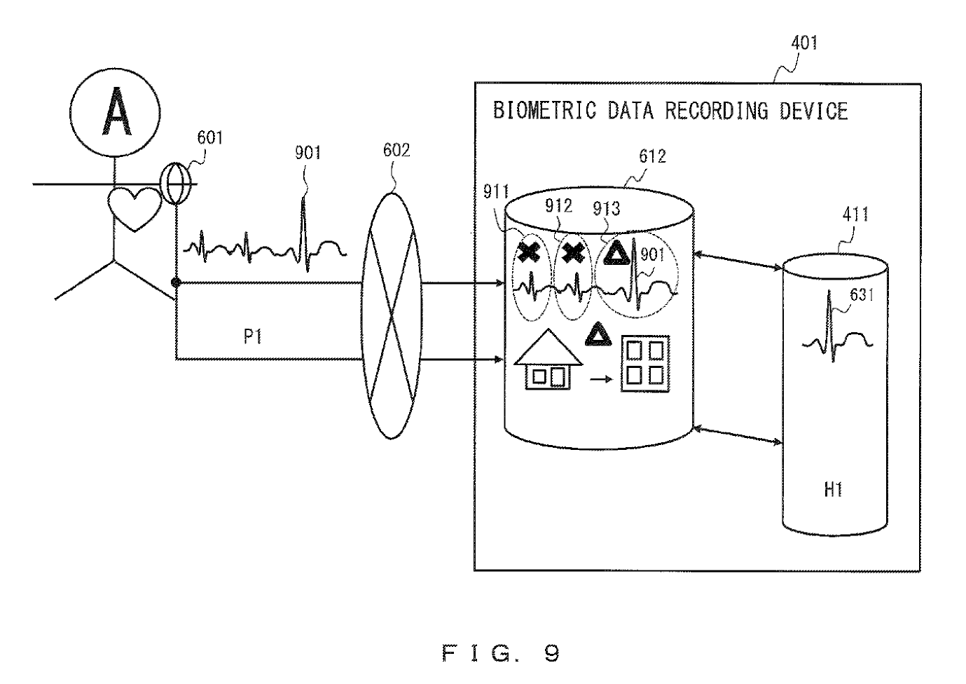

FIG. 9 illustrates an example of auxiliary authentication. The wearable device 601 picks up electrocardiogram data 901 of user A and detects the position data P1 of user Aso as to transmit the electrocardiogram data 901 and the position data P1 to the biometric data recording device 401. The biometric data recording device 401 compares the electrocardiogram data 901 with the reference data 631 of user A.

In the electrocardiogram data 901, the data portions of past periods 911 and 912 represent the electrocardiograms when the user A is in a poor physical condition, while the data portion of a current period 913 represents the electrocardiogram when the physical condition of user A has recovered.

In such a case, because the data portion of the period 913 is approximate to the reference data 631 while none of the data portions of the periods 911 through 913 corresponds to the reference data 631, the biometric data recording device 401 compares the position data P1 with movement history H1 of user A. When the movement history represented by the position data P1 corresponds to movement history H1, the biometric data recording device 401 records the electrocardiogram data 901 including the data portions of the periods 911 through 913 in the result information storage unit 611 as the electrocardiogram data of user A.

As described above, when electrocardiogram data suggests a possibility that the person is the true subject, by using another piece of measured data so as to further confirm that the person is the subject, it is possible to record all pieces of electrocardiogram data after user A put on the wearable device 601, similarly to the case of FIG. 8.

The biometric data recording device 401 may start a biometric data recording process when user A puts on the wearable device 601. In such a case, the biometric data recording device 401 detects reception and interruptions of electrocardiogram data and thereby can detect the putting on and taking off of the wearable device 601. When transmission of electrocardiogram data from the wearable device 601 is interrupted due to some reason, the biometric data recording device 401 again performs an authentication process at a timing when the transmission is resumed. Periodical identity confirmation may be conducted or does not have to be conducted.

When authentication has failed a prescribed number of times, the biometric data recording device 401 may perform a registration process in which received electrocardiogram data is registered as electrocardiogram data of a new user. Whether or not to permit the registration of a new user may be specified on the basis of setting information.

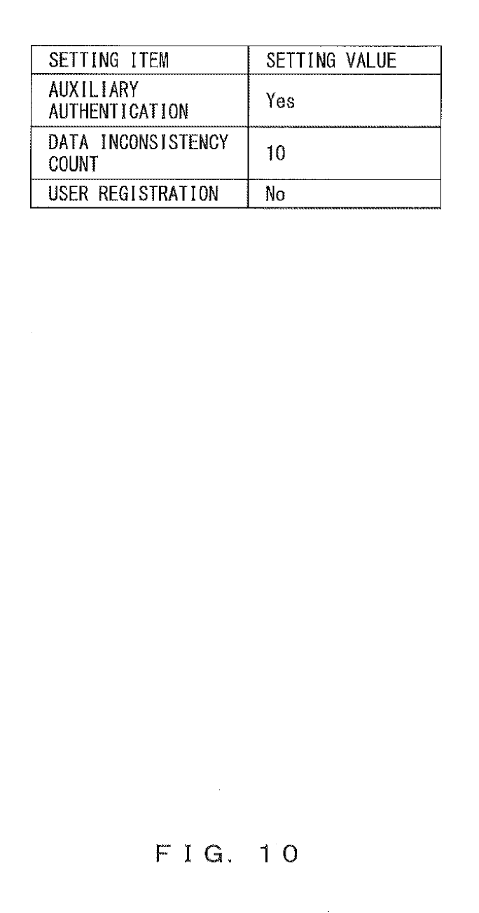

FIG. 10 illustrates an example of setting information stored in the setting information storage unit 613. The setting information illustrated in FIG. 10 contains setting items and setting values, and is updated when for example the system is constructed. A setting item represents the type of a parameter in a biometric data recording process, while a setting value represents the value of a parameter. “Auxiliary authentication” represents whether or not the auxiliary authentication is valid. “Data inconsistency count” represents a threshold for the number of times that authentication fails, while “user registration” represents whether or not to permit registration of a new user when authentication has failed the number of times represented by data inconsistency count. In this example, “auxiliary authentication” is valid (Yes), “data inconsistency count” is 10, and “user registration” is prohibited (No).

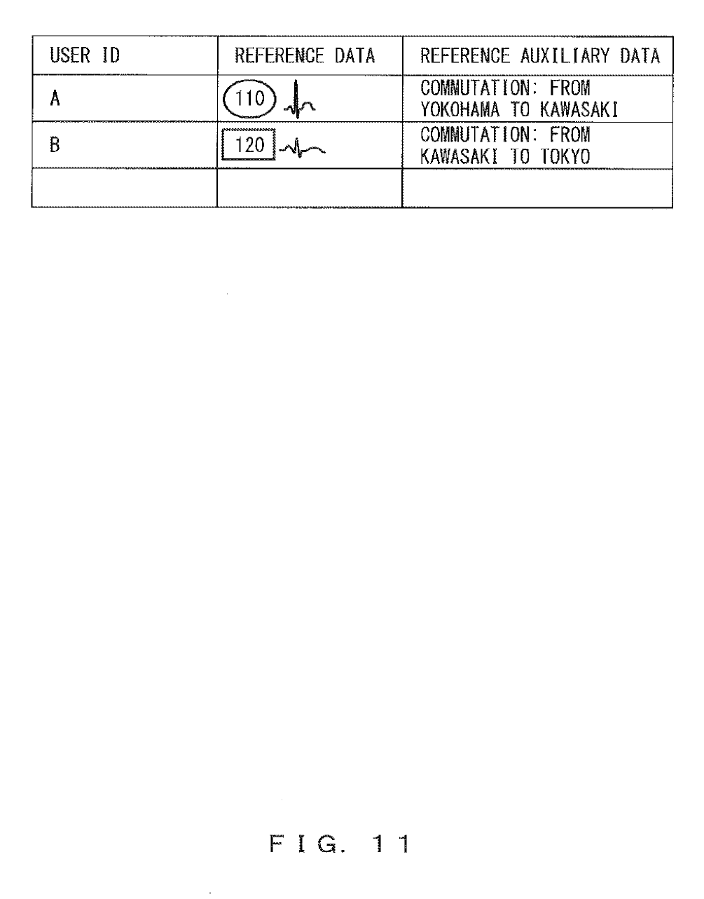

FIG. 11 illustrates examples of reference data and reference auxiliary data stored in the reference data storage unit 411. The reference data storage unit 411 is updated upon for example the start of the use by the user. A user ID represents the identification information of the user, reference data represents electrocardiogram data serving as a reference for biometric authentication and the characteristic amount thereof, and reference auxiliary data represents a movement history that serves as a reference for auxiliary authentication. The biometric data recording device 401 divides the waveform of the electrocardiogram data for each period so as to extract information such as the shape, amplitude, wavelength, etc. of the waveform, and records the extracted information as a characteristics amount.

For example, the characteristic amount of the reference data of user A is 110, while the reference auxiliary data represents a commutation route from Yokohama to Kawasaki. Also, the characteristic amount of reference data of user B is 120, while the reference auxiliary data represents a commutation route from Kawasaki to Tokyo.

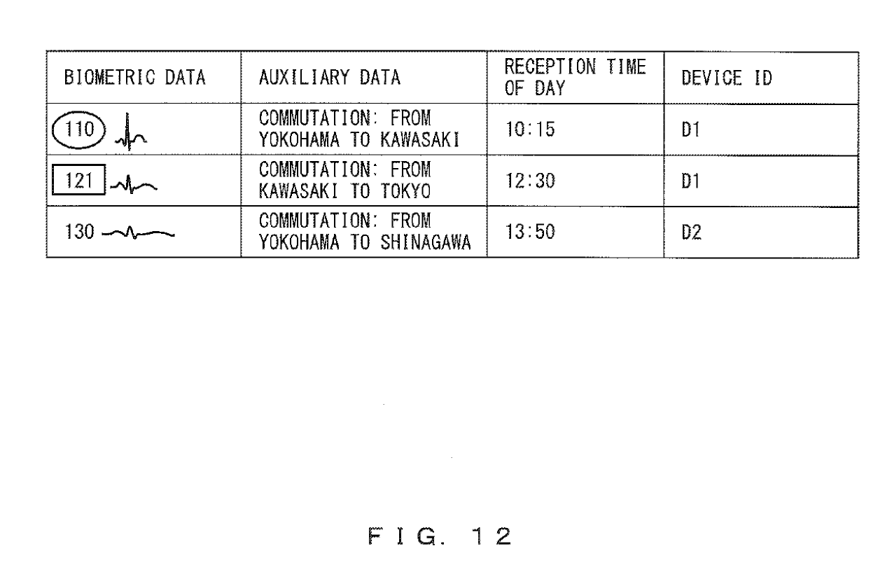

FIG. 12 illustrates an example of reception information stored in the reception information storage unit 612. The reception information illustrated in FIG. 12 contains biometric data, auxiliary data, reception time and device IDs, and is updated when for example biometric data is received. Biometric data represents received electrocardiogram data and the characteristic amount thereof, while auxiliary data represents position data at which the electrocardiogram data was received. Reception time represents time at which electrocardiogram data and position data were received, while a device ID represents the identification information of a wearable device that transmitted the electrocardiogram data and the position data.

For example, the characteristic amount of electrocardiogram data received at 10:15 is 110, the position data received at the same time represents a commutation route from Yokohama to Kawasaki, and the device ID is D1. Also, the characteristic amount of electrocardiogram data received at 13:50 is 130, the position data received at the same time represents a commutation route from Yokohama to Shinagawa, and the device ID is D2.

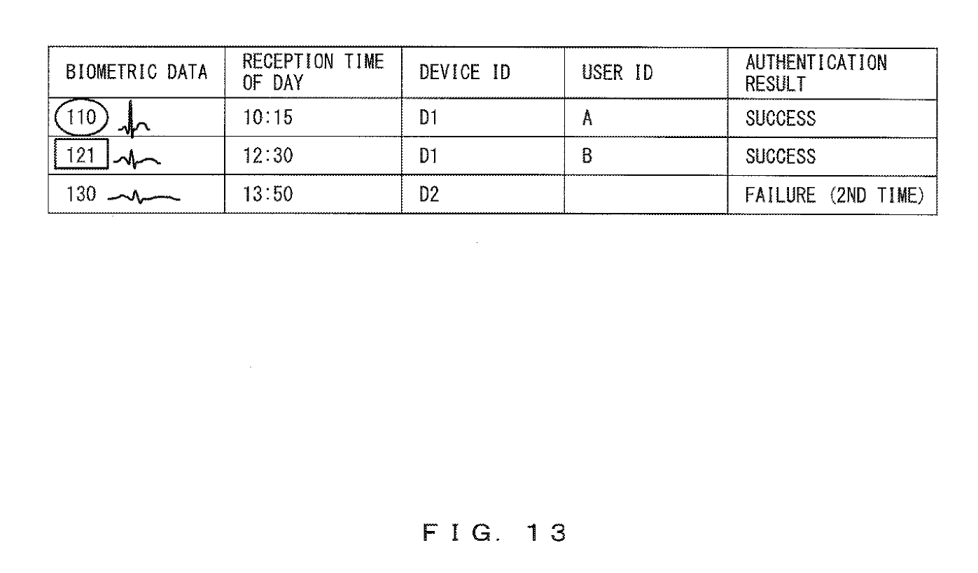

FIG. 13 illustrates an example of result information stored in the result information storage unit 611. The result information illustrated in FIG. 13 contains biometric data, reception time, device IDs, user IDs and authentication results, and is updated when for example biometric data is received and when an authentication process is performed. In this example, position data is not contained in consideration of the privacy of the users.

Biometric data represents the received electrocardiogram data and the characteristic amount thereof, reception time represents the time at which the electrocardiogram data was received, and a device ID represents the identification information of a wearable device that transmitted the electrocardiogram data. A user ID represents the identification information of a user identified in an authentication process, and an authentication result represents one of “success”, “failure” and “not conducted” for the authentication. When an authentication result indicates “failure”, the number of the failures is also recorded.

For example, the authentication result of the electrocardiogram data received at 10:15 indicates “success”, and the identified user is user A. Also, the authentication result of the electrocardiogram data received at 13:50 indicates “failure”, and the failure count is 2. In such a case, no user will be identified as a user corresponding to the received electrocardiogram data.

In FIG. 11 through FIG. 13, each entry records the waveform of one pulse of the electrocardiogram data, while an arbitrary period of electrocardiogram data may be recorded for each entry and waveforms of two or more pulses may be recorded.

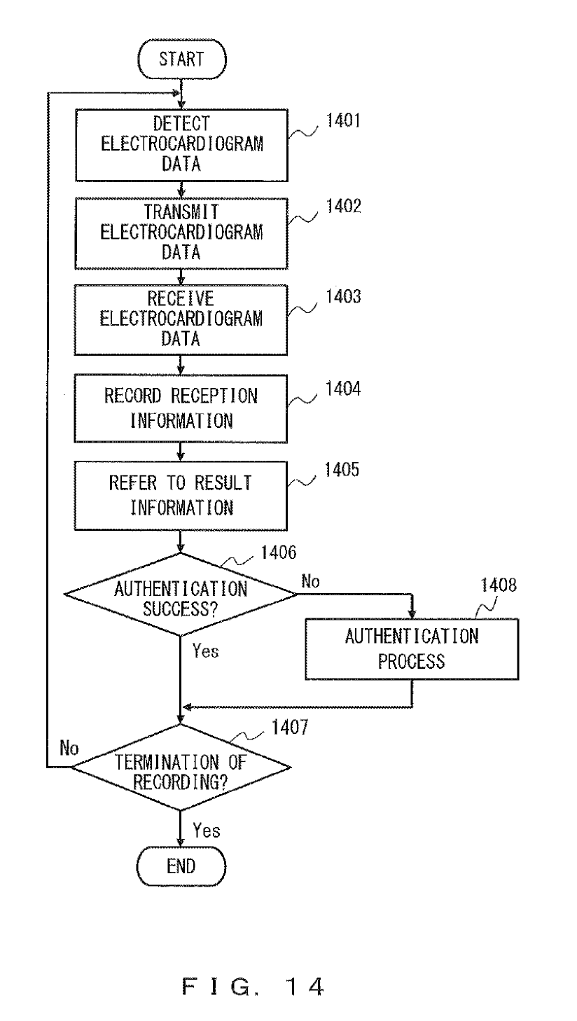

FIG. 14 is a flowchart illustrating a specific example of a biometric data recording process performed by the biometric data recording device 401 illustrated in FIG. 6. First, the wearable device 601 detects electrocardiogram data by using an electrocardiogram sensor, and detects position data by using a position sensor. Then, the wearable device 601 transmits the detected electrocardiogram data and position data to the biometric data recording device 401 (step 1402).

The obtainment unit 413 of the biometric data recording device 401 receives the electrocardiogram data and the position data from the wearable device 601 (step 1403) so as to record them in the reception information storage unit 612 (step 1404). Then, the authentication unit 621 generates an entry in the result information storage unit 611, and records the received electrocardiogram data as the biometric data of that entry, and also records “not conducted” as an authentication result.

Next, the authentication unit 621 refers to the authentication result of the entry in the result information storage unit 611 (step 1405) so as to check whether the authentication result indicates “success” (step 1406). When the authentication result indicates “failure” or “not conducted” (No in step 1406), the authentication unit 621 performs an authentication process (step 1408). Then, the authentication unit 621 determines whether or not to terminate the recording of electrocardiogram data (step 1407).

When for example user A terminates the measurement of electrocardiogram data, when the user A takes off the wearable device 601 or when user A turns off the wearable device 601, the transmission of the electrocardiogram data is interrupted. Accordingly, the authentication unit 621 can determine to terminate the recording of electrocardiogram data when the reception of the electrocardiogram data has been interrupted. Also, the authentication unit 621 may determine to terminate the recording of electrocardiogram data when a prescribed termination condition is met.

When the recording of electrocardiogram data is not to be terminated (No in step 1407), the biometric data recording device 401 repeats the processes in and after step 1401. When the recording of electrocardiogram data is to be terminated (Yes in step 1407), the biometric data recording device 401 termites the process. When the authentication result indicates “success” (Yes in step 1406), the authentication unit 621 performs the processes in and after step 1407 without perform an authentication process.

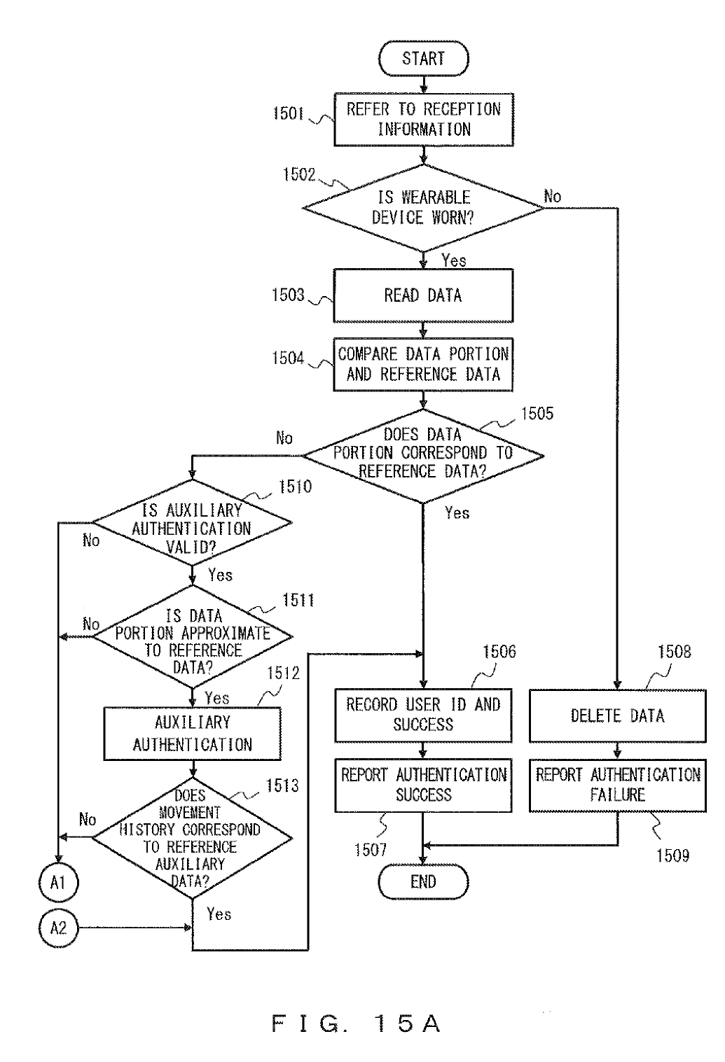

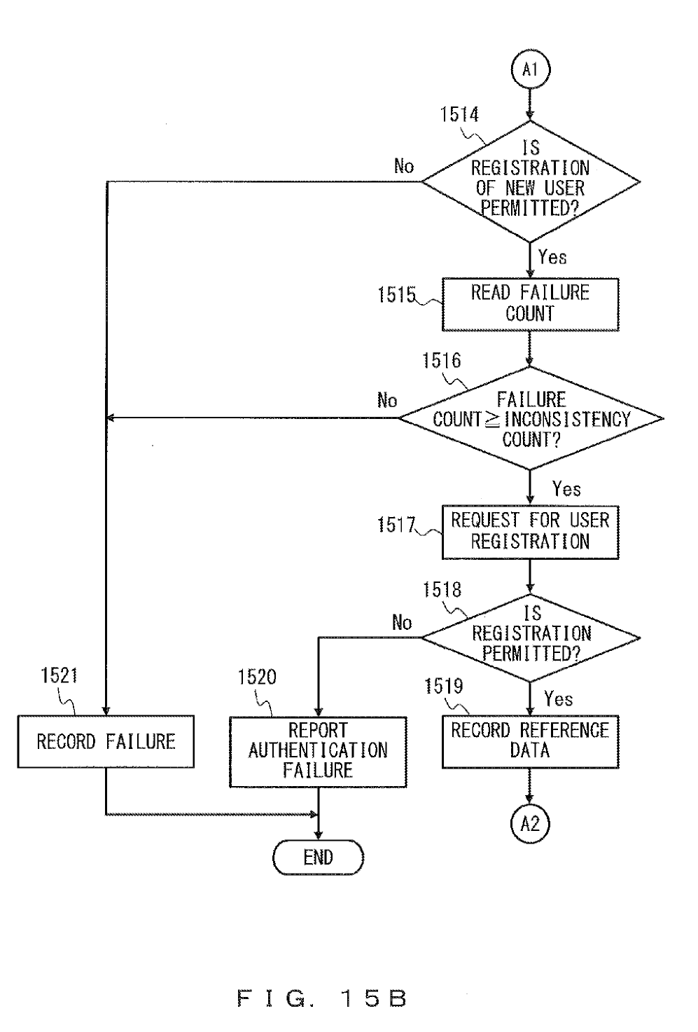

FIG. 15A and FIG. 15B are flowcharts illustrating an example of an authentication process in step 1408 illustrated in FIG. 14. First, the authentication unit 621 refers to an entry in the reception information storage unit 612 (step 1501) so as to check the wearing status of the wearable device 601 (step 1501).

For example, the authentication unit 621 can check the wearing status of the wearable device 601 on the basis of whether or not the recorded electrocardiogram data is an valid value. When the electrocardiogram data is varying within a prescribed range and has not been interrupted, the wearable device 601 is determined to be worn. When the electrocardiogram data is out of the prescribed range or has been interrupted, the wearable device 601 is determined to not be worn.

When the wearable device 601 is not worn (No in step 1502), the authentication unit 621 deletes the received electrocardiogram data and position data from the reception information storage unit 612 and the result information storage unit 611 (step 1508). Then, the authentication unit 621 transmits a report of a failure of the authentication to the wearable device 601 (step 1509), and terminates the process.

When the wearable device 601 is worn (Yes in step 1502), the authentication unit 621 reads the electrocardiogram data from the reception information storage unit 612 and also reads each piece of reference data from the reference data storage unit 411 (step 1503). Then, the authentication unit 621 compares the data portion of the latest period in the read electrocardiogram data and each piece of reference data (step 1504) so as to check whether or not they correspond to each other (step 1505).

For example, when the difference in characteristic amount between the data portion of the latest period and a piece of reference data is equal to or smaller than threshold TH1, the authentication unit 621 determines that data portion to correspond to the piece of reference data. When the difference is greater than threshold TH1, the authentication unit 621 determines that data portion to not correspond to the piece of reference data. Whether or not two pieces of electrocardiogram data correspond to each other can also be determined by using a method described in Non-Patent Documents 1 or 2.

When the data portion of the latest period corresponds to one of the pieces of reference data (Yes in step 1505), the authentication unit 621 records the user ID of that piece of reference data as the user ID of an entry in the result information storage unit 611 (step 1506). Also, the authentication unit 621 records “success” as the authentication result of the entry in the result information storage unit 611. Thereby, received electrocardiogram data is recorded in the result information storage unit 611 in association with the user ID of a piece of reference data. The authentication unit 621 transmits a report of success of the authentication to the wearable device 601 (step 1507), and terminates the process.

When the data portion of the latest period does not correspond to any piece of reference data (No in step 1505), the authentication unit 621 refers to setting information in the setting information storage unit 613 so as to check whether or not the auxiliary authentication is valid (step 1510). When the auxiliary authentication is valid (Yes in step 1510), the authentication unit 621 checks whether or not the data portion of the latest period is approximate to each piece of reference data (step 1511).

For example, when the difference in characteristic amount between the data portion of the latest period and a piece of reference data is equal to or smaller than threshold TH2, which is greater than threshold TH1, the authentication unit 621 determines that data portion to be approximate to the piece of reference data. When the difference is greater than threshold TH2, the authentication unit 621 determines that data portion to be not approximate to the piece of reference data.

When the data portion of the latest period is approximate to one of the pieces of reference data (Yes instep 1511), the authentication unit 621 calls the auxiliary authentication unit 622 and the auxiliary authentication unit 622 conducts auxiliary authentication (step 1512). Then, the auxiliary authentication unit 622 uses map information stored in the authentication-related information storage unit 614 so as to compare received position data with reference auxiliary data stored in the reference data storage unit 411. The auxiliary authentication unit 622 thereafter checks whether or not the movement history represented by the position data corresponds to the reference auxiliary data (step 1513). Whether or not two movement histories correspond to each other can be determined by for example the authentication method described in Non-Patent Documents 4.

When the movement history represented by position data corresponds to reference auxiliary data (Yes instep 1513), the authentication unit 621 determines the data portion of the latest period in the electrocardiogram data to correspond to a piece of reference data so as to perform the processes in and after step 1506.

When auxiliary authentication is invalid (No in step 1510), the authentication unit 621 refers to setting information in the setting information storage unit 613 so as to check whether or not registration of a new user is permitted (step 1514).

When registration of a new user is permitted (Yes in step 1514), the authentication unit 621 reads the failure count represented by the authentication result from the result information storage unit 611 and reads the data inconsistency count from the setting information (step 1515). Then, the authentication unit 621 compares the failure count and the data inconsistency count (step 1516).

When the failure count is equal to or greater than the data inconsistency count (Yes in step 1516), the authentication unit 621 transmits, to the wearable device 601, a request for user registration, and receives a reply of the user from the wearable device 601 (step 1517). Then, the authentication unit 621 checks the received reply (step 1518).

When the user permits the registration (Yes in step 1518), the authentication unit 621 records, in the reference data storage unit 411, the received electrocardiogram data and the movement history represented by the received position data respectively as reference data and reference auxiliary data (step 1519). Then, the authentication unit 621 determines the authentication to be success, and performs the processes in and after step 1506.

As described above, by recording information permitting registration of a new user as setting information, an unrecorded user can automatically be registered in the reference data storage unit 411 as a new user when such a user transmits electrocardiogram data.

When the user does not permit registration (No in step 1518), the authentication unit 621 transmits a report of a failure of the authentication to the wearable device 601 (step 1520) so as to terminate the process.

When the data portion of the latest period is not approximate to any piece of reference data (No in step 1511) or when the movement history of the position data does not correspond to the reference auxiliary data (No in step 1513), the authentication unit 621 performs the processes in and after step 1514.

When registration of a new user is not permitted (No in step 1514), the authentication unit 621 records “failure” and the number of times of failure as the authentication result of an entry in the result information storage unit 611 (step 1521) so as to terminate the process. When the number of times of failure is smaller than the data inconsistency count as well (No in step 1516), the authentication unit 621 performs the process in step 1521.

The biometric data recording process illustrated in FIG. 4 results in the effects below.

(a) Because the fact that received electrocardiogram data belongs to the true subject is confirmed by using the received electrocardiogram data itself, it is easy to detect an impersonation, making it possible to conduct identity confirmation securely.

(b) Because electrocardiogram data picked up by a wearable device is used by a biometric data recording device for performing an authentication process, there is no need for the wearable device to be additionally provided with a special component, software, etc. for an authentication process. This makes it possible to use, without modifications, an existing wearable device that can measure electrocardiogram data.

(c) Because personal authentication is automatically conducted just in response to putting on of a wearable device, labor of the user is reduced.

(d) Because reauthentication is automatically conducted when a wearable device is put on or taken off and when a communication network is disconnected, the fact that the person wearing the wearable device is the true subject is confirmed without making the user conscious of it.

(e) It is easy for a plurality of users such as family members, coworkers, etc. to use the same wearable device, making it possible to automatically separate pieces of electrocardiogram data so as to record them for respective wearing persons.

(f) Even in an environment in which biometric authentication may fail easily due to the measurement accuracy of a wearable device, the state or physical condition of the user, etc., biometric authentication can be conducted and all pieces of electrocardiogram data can be recorded after the putting on of the wearable device.

Next, by using specific examples of electrocardiogram data and position data, an example of biometric data recording process will be explained. It is assumed in the initial state that the setting information storage unit 613 has stored the setting information illustrated in FIG. 10 and the reference data storage unit 411 has stored the reference data and the reference auxiliary data illustrated in FIG. 11.

Also, a value equivalent to 0.1% of the characteristic amount of reference data is used as threshold TH1 in step 1505 in FIG. 15A and a value equivalent to 5% of the characteristic amount of reference data is used as threshold TH2 in step 1511.

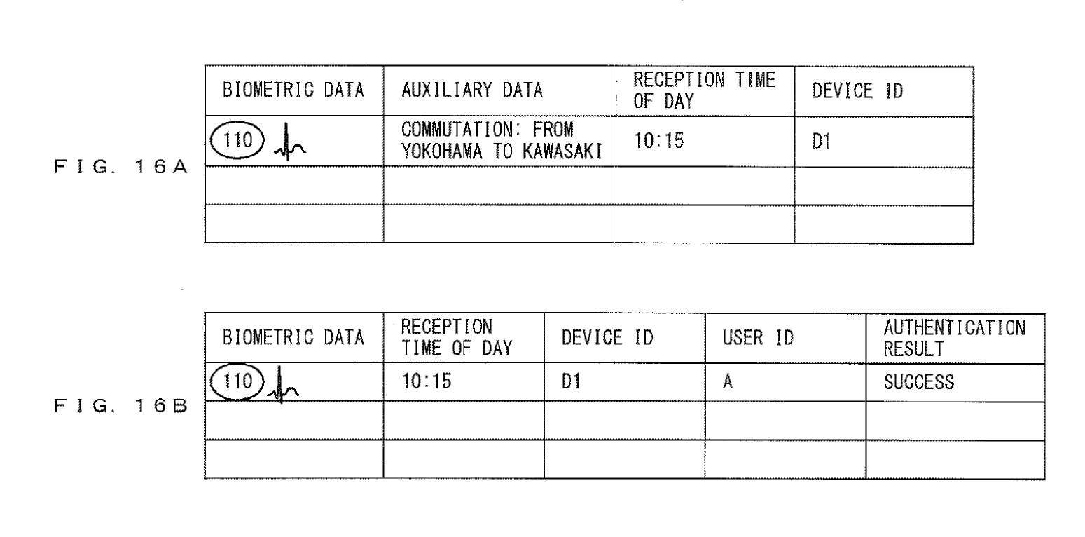

FIG. 16A and FIG. 16B illustrate examples of reception information and result information, respectively, in the initial state. The reception information illustrated in FIG. 16A contains electrocardiogram data and position data received from wearable device D1 at 10:15. The characteristic amount of the electrocardiogram data is 110, and the position data represents a commutation route from Yokohama to Kawasaki. The result information illustrated in FIG. 16B contains an authentication result for the reception information illustrated in FIG. 16B. In this case, the authentication result is success and the identified user is user A.

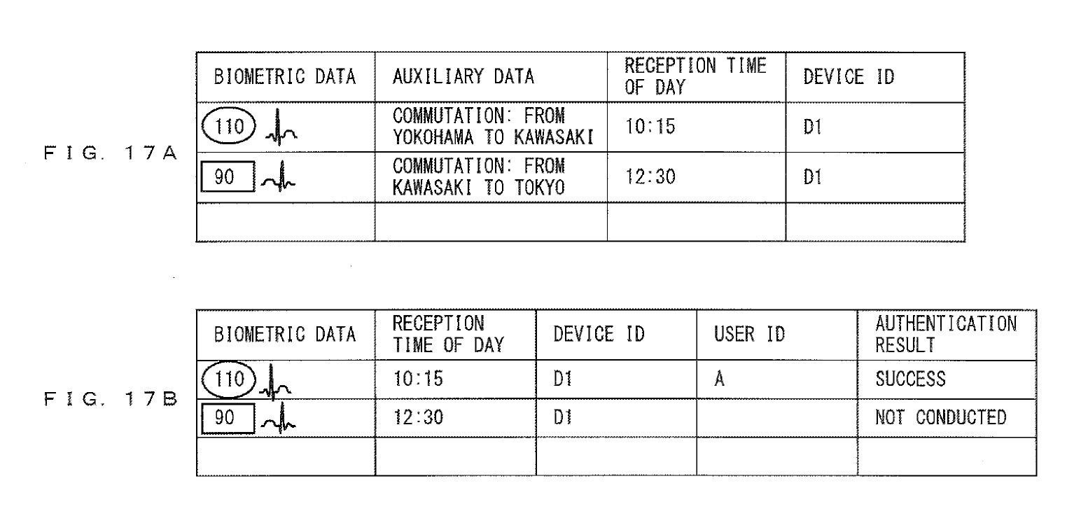

In this state, when user B puts on wearable device D1 and transmits electrocardiogram data to the biometric data recording device 401 at 12:30, the reception information and the result information are updated as illustrated in FIG. 17A and FIG. 17B, respectively. The reception information illustrated in FIG. 17A contains the electrocardiogram data and the position data received from wearable device D1 at 12:30. The characteristic amount of the electrocardiogram data is 90, which is an abnormal value due to poor physical condition etc., while the position data represents a commutation route from Kawasaki to Tokyo. The result information illustrated in FIG. 17B contains an entry corresponding to the electrocardiogram data received at 12:30, and “not conducted” is recorded as the authentication result of the entry.

In this case, because the characteristic amount of the received electrocardiogram data is 90, the authentication unit 621 determines that the received electrocardiogram data is valid and that wearable device D1 is in an worn state. Then, the authentication unit 621 compares, with TH1, a difference between the characteristic amount of the received electrocardiogram data and the characteristic amount of each piece of reference data of FIG. 11.

The characteristic amount of reference data of user A is 110, resulting in TH1=110×0.001=0.11. In such a case, the difference between the characteristic amounts satisfies |90−110|=20>TH1, leading to determination that the received electrocardiogram data does not correspond to the reference data of user A.

Also, the characteristic amount of reference data of user B is 120, resulting in TH1=120×0.001=0.12. In such a case, the difference between the characteristic amounts satisfies |90−120|=30>TH1, leading to determination that the received electrocardiogram data does not correspond to the reference data of user B, either. As described above, the received electrocardiogram data does not correspond to any of the pieces of reference data illustrated in FIG. 11.

Because the setting information illustrated in FIG. 10 indicates that the auxiliary authentication is valid, the authentication unit 621 next compares the difference with TH2. The characteristic amount of the reference data of user A is 110, resulting in TH2=110×0.05=5.5. In such a case, a difference 20 is greater than TH2, leading to determination that the received electrocardiogram data is not approximate to the reference data of user A.

Also, the characteristic amount of the reference data of user B is 120, resulting in TH2=120×0.05=6. In such a case, a difference 30 is greater than TH2, leading to determination that the received electrocardiogram data is not approximate to the reference data of user B, either. As described above, the received electrocardiogram data is not approximate to any of the pieces of reference data illustrated in FIG. 11.

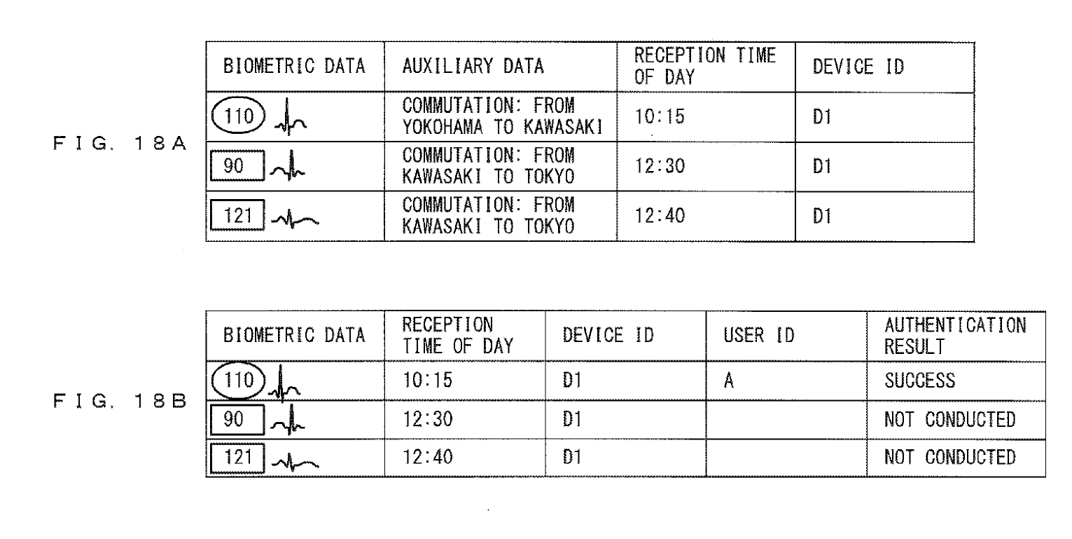

Because the setting information illustrated in FIG. 10 indicates that registration of a new user is not permitted, the authentication unit 621 performs an authentication process for the next piece of reception information. When wearable device D1 transmits electrocardiogram data of user B to the biometric data recording device 401 at 12:40, the reception information and the result information are updated as illustrated in FIG. 18A and FIG. 18B, respectively.

The reception information illustrated in FIG. 18A contains the electrocardiogram data and the position data received from wearable device D1 at 12:40. The characteristic amount of the electrocardiogram data is 121, while the position data represents a commutation route from Kawasaki to Tokyo. The result information illustrated in FIG. 18B contains an entry corresponding to the electrocardiogram data received at 12:40, and “not conducted” is recorded as the authentication result of the entry.

In this case, because the characteristic amount of the received electrocardiogram data is 121, the authentication unit 621 determines that the received electrocardiogram data is valid and that wearable device D1 is in an worn state. Then, the authentication unit 621 compares, with TH1, a difference between the characteristic amount of the received electrocardiogram data and the characteristic amount of each piece of reference data of FIG. 11.

TH1 for the reference data of user A is 0.11. In such a case, the difference between the characteristic amounts satisfies |121−110|=11>TH1, leading to determination that the received electrocardiogram data does not correspond to the reference data of user A. TH1 for the reference data of user B is 0.12. In such a case, the difference between the characteristic amounts satisfies |121−120|=1>TH1, leading to determination that the received electrocardiogram data does not correspond to the reference data of user B, either. As described above, the received electrocardiogram data does not correspond to any of the pieces of reference data illustrated in FIG. 11.

Because the auxiliary authentication is valid, the authentication unit 621 next compares the difference with TH2. TH2 for the reference data of user A is 5.5. In such a case, the difference 20 is greater than TH2, leading to determination that the received electrocardiogram data is not approximate to the reference data of user A.

TH2 for the reference data of user B is 6. In such a case, difference 1 is smaller than TH2, leading to determination that the received electrocardiogram data is approximate to the reference data of user B. Then, the auxiliary authentication unit 622 checks whether or not the movement history represented by the received position data corresponds to the reference auxiliary data of user B. In such a case, the movement history represented by the received position data is a commutation route from Kawasaki to Tokyo, leading to determination that the movement history corresponds to the reference auxiliary data of user B.

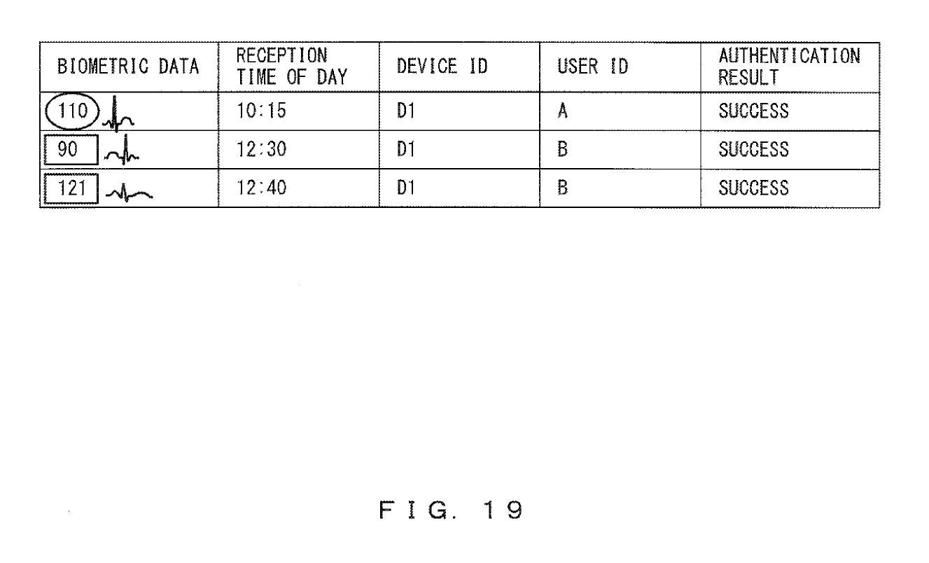

Then, the authentication unit 621, as illustrated in the result information of FIG. 19, records “success” as the authentication results in the two entries with 12:30 and 12:40, and also records the user ID of user B as a user ID. Thereby, the electrocardiogram data, containing the abnormal value received at 12:30, of the two entries are recorded in association with the user ID of user B.

Note that when electrocardiogram data is to be recorded after success of authentication as in the conventional techniques, only electrocardiogram data received at 12:40 is recorded and the abnormal value received at 12:30 is not recorded.

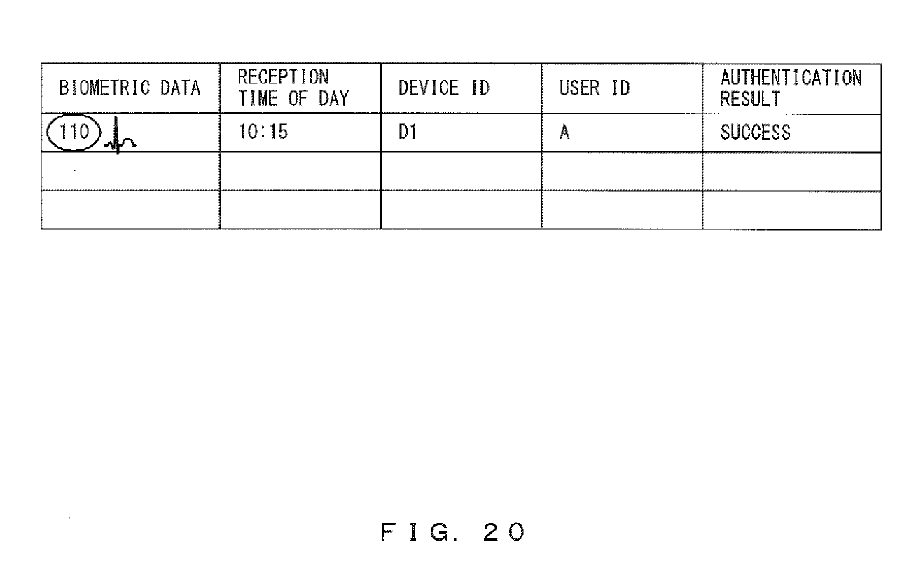

Also, when user B takes off wearable device D1 before 12:40, the reception of the electrocardiogram data is interrupted at that moment. In such a case, the authentication unit 621 deletes the entry of the electrocardiogram data received at 12:30 so as to discard that electrocardiogram data as illustrated as the result information in FIG. 20.

While the biometric data recording device 401 illustrated in FIG. 6 records electrocardiogram data in the reception information storage unit 612 and the result information storage unit 611, electrocardiogram data may be recorded in a different storage unit. In such a case, identification information for referring to electrocardiogram data is recorded in entries in the reception information storage unit 612 and the result information storage unit 611.

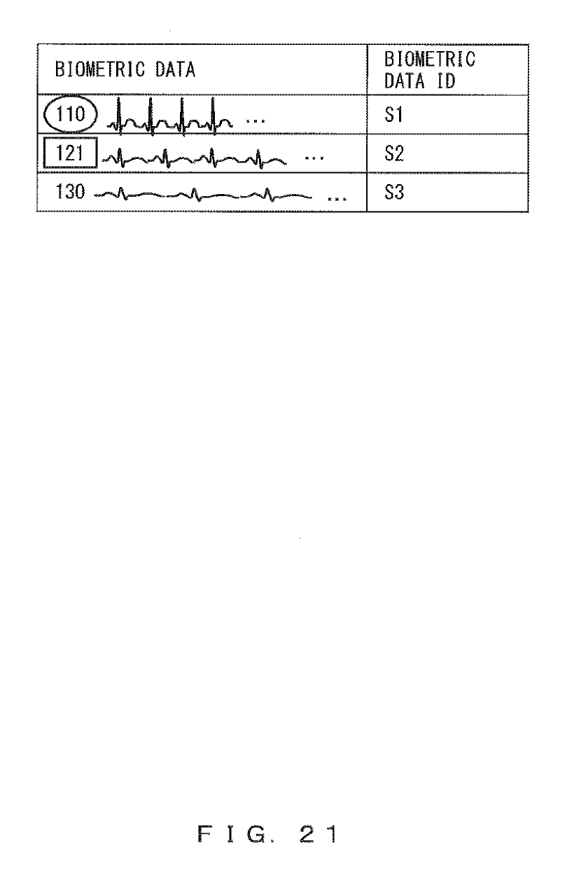

FIG. 21 illustrates an example of biometric data stored in a storage unit that is provided independently from the reception information storage unit 612 and the result information storage unit 611. Biometric data represents received electrocardiogram data and the characteristic amount thereof, and biometric data ID represents the ID of the electrocardiogram data. In such a case, one of the biometric data IDs is recorded as biometric data of each entry in the reception information storage unit 612 and the result information storage unit 611.

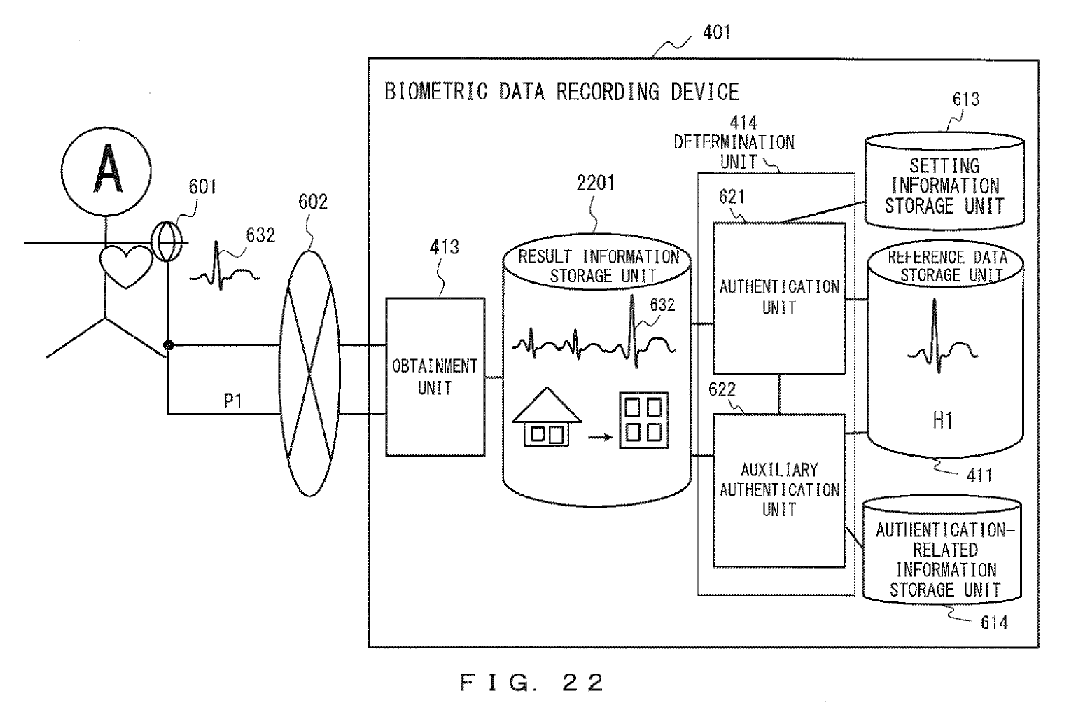

FIG. 22 illustrates a second specific example of the biometric data recording device 401 illustrated in FIG. 4. The biometric data recording device 401 illustrated in FIG. 22 employs a configuration obtained by replacing the result information storage unit 611 and the reception information storage unit 612 of FIG. 6 with a result information storage unit 2201. The result information storage unit 2201 stores information resulting from merging reception information stored in the reception information storage unit 612 and result information stored in the result information storage unit 611. In such a case, the determination unit 414 performs a biometric data recording process by using the result information storage unit 2201 instead of the result information storage unit 611 and the reception information storage unit 612.

The biometric data recording device 401 of FIG. 6 and FIG. 22 may use other types of biometric data that represent pulses, breathing, body temperatures, blood pressures, blood circulation, blood sugar levels, brain waves, sleep, exercise amounts, walking patterns, movement patterns, etc. Biometric data may be detected by using a measurement device other than the wearable device 601.

Also, the biometric data recording device 401 may use different types of auxiliary data such as comments on electrocardiogram data, lifestyles, exercise characteristics, etc. instead of movement histories. A comment on electrocardiogram data represents a chronic disease etc., and a lifestyle represents a wake-up time, a mealtime, a taking-bathe time, a bedtime, etc., and a exercise characteristic represents a walking speed, a stride, a way of walking.

When a piece of biometric data that is completely identical with a piece of biometric data that was used in the past is received, the determination unit 414 can prohibit the use of the identical piece of biometric data in an authentication process. This prevents unauthorized accesses that use a copy signal of biometric data. The determination unit 414 may also conduct personal authentication based on IDs, passwords, IC chips, fingerprints, etc. in addition to biometric authentication based on biometric data.

It is also possible to pick up an image of the face of the user by using the wearable device 601 or a camera included in a smart device etc. so as to transmit the image to the biometric data recording device 401 together with biometric data. Thereby, the image of the user from whom the biometric data is picked up is recorded as evidence. Accordingly, even when impersonation occurs upon the registration of reference data in the reference data storage unit 411, it is possible to detect the impersonation by comparing the images. Alternatively, it is also possible to have reference data registered in a facility that uses biometric data such as medial institutions, insurance companies, etc.

The biometric data recording device 401 can also be used for identity confirmation for medical examinations or surgeries in hospitals. When for example identity confirmation is conducted on the basis of electrocardiogram data that is measured during a surgery, it is possible to detect confusion even when confusion has occurred between patients immediately before the surgery or in other cases.

The configurations of the biometric data recording device 401 illustrated in FIG. 4, FIG. 6 and FIG. 22 are just examples, and some of the constituents can be omitted or changed in accordance with the purposes or conditions of the biometric data recording device 401. For example, when auxiliary authentication is not conducted and a new user is not registered, the setting information storage unit 613, the authentication-related information storage unit 614 and the auxiliary authentication unit 622 illustrated in FIG. 6 and FIG. 22 can be omitted.

The flowcharts illustrated in FIG. 5, FIG. 14, FIG. 15A and FIG. 15B are just examples, and some of the processes can be omitted or changed in accordance with the configurations or conditions of the biometric data recording device 401. When for example auxiliary authentication is not conducted, the processes in step 1510 through step 1513 illustrated in FIG. 15A can be omitted, and the processes in step 1514 through 1520 illustrated in FIG. 15B can be omitted when a new user is not registered.

The setting information illustrated in FIG. 10 and the reference data and the reference auxiliary data illustrated in FIG. 11 are just examples, and different pieces of setting information, reference data and reference auxiliary data may be used in accordance with the configurations or conditions of the biometric data recording device 401. The reception information and the result information illustrated in FIG. 12, FIG. 13 and FIG. 16A through FIG. 20 are just examples, and different pieces of reception information and result information may be used in accordance with the configurations or conditions of the biometric data recording device 401. The electrocardiogram data illustrated in FIG. 21 is just an example, and a different piece of electrocardiogram data may be used in accordance with the configurations or conditions of the biometric data recording device 401.

For example, in the reference data storage unit 411, the result information storage unit 611 and the reception information storage unit 612, a table may be provided for each piece of electrocardiogram data.

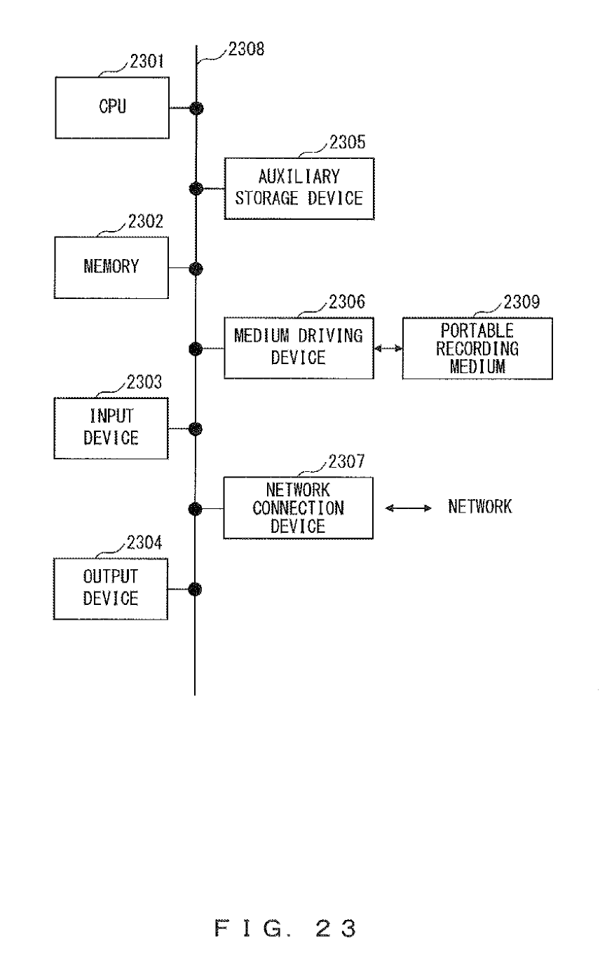

The biometric data recording device 401 illustrated in FIG. 4, FIG. 6 and FIG. 22 may be implemented by using for example an information processing apparatus (computer) such as one illustrated in FIG. 23.

The information processing apparatus illustrated in FIG. 23 includes a Central Processing Unit (CPU) 2301, a memory 2302, an input device 2303, an output device 2304, an auxiliary storage device 2305, a medium driving device 2306 and a network connection device 2307. These constituents are connected to each other via a bus 2308.

The memory 2302 is for example a semiconductor memory such as a Read Only Memory (ROM), a Random Access Memory (RAM), a flash memory, etc., and stores a program and data used for the biometric information registration process. The memory 2302 can be used as the reference data storage unit 411, the biometric data storage unit 412, the result information storage unit 611, the reception information storage unit 612, the setting information storage unit 613, the authentication-related information storage unit 614 and the result information storage unit 2201 illustrated in FIG. 4, FIG. 6 and FIG. 22.

The CPU 2301 (processor) executes a program by using for example the memory 2302 so as to operate as the determination unit 414, the authentication unit 621 and the auxiliary authentication unit 622 illustrated in FIG. 4, FIG. 6 and FIG. 22.

The input device 2303 is for example a keyboard, a pointing device, etc., and is used for inputting instructions or information from the operator or the user. The output device 2304 is for example a display device, a printer, a speaker, etc., and is used for outputting inquiries or instructions to the operator or the user and for outputting process results. A process result may be an authentication result contained in result information.

The auxiliary storage unit 2305 is for example a magnetic disk device, an optical disk device, a magneto-optical disk device, a tape device, etc. The auxiliary storage unit 2305 may be a hard disk drive. The information processing apparatus can store a program and data in the auxiliary storage unit 2305 beforehand so as to load them onto the memory 2302 and use them. The auxiliary storage unit 2305 may be used as the reference data storage unit 411, the biometric data storage unit 412, the result information storage unit 611, the reception information storage unit 612, the setting information storage unit 613, the authentication-related information storage unit 614 and the result information storage unit 2201 illustrated in FIG. 4, FIG. 6 and FIG. 22.

The medium driving device 2306 drives a portable recording medium 2309 so as to access information recorded in it. The portable recording medium 2309 is a memory device, a flexible disk, an optical disk, a magneto-optical disk, etc. The portable recording medium 2309 may be a Compact Disk Read Only Memory (CD-ROM), a Digital Versatile Disk (DVD), a Universal Serial Bus (USB) memory, etc. The operator or the user can store a program and data in the portable recording medium 2309 so as to load them onto the memory 2302 and use them.

As described above, a computer-readable recording medium that stores a program and data used for the biometric data recording process is a physical (non-transitory) recording medium such as the memory 2302, the auxiliary storage unit 2305 or the portable recording medium 2309.

The network connection device 2307 is a communication interface that is connected to a communication network such as a Local Area Network, a Wide Area Network, etc. so as to perform the conversion of data used for communications. The information processing apparatus can receive a program and data from an external device via the network connection device 2307 so as to load them onto the memory 2302 and use them. The network connection device 2307 can be used as the obtainment unit 413 illustrated in FIG. 4, FIG. 6 and FIG. 22.

Note that it is not necessary for the information processing apparatus to include all the constituents illustrated in FIG. 23, and some of the constituents can be omitted in accordance with the purposes or conditions. For example, when it is not necessary to input instructions or information from the operator or the user, the input device 2303 can be omitted. When it is not necessary to output inquiries or instructions to the operator or the user and to output a process result, the output device 2304 can be omitted. When the portable recording medium 2309 is not used, the medium driving device 2306 can be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A biometric data recording method comprising:
obtaining time-series biometric data detected by a sensor;
determining whether or not a part of the obtained biometric data corresponds to reference data stored in a memory by referring to the memory storing the reference data in association with a subject; and
recording, by a computer, the obtained biometric data in association with the subject that is associated with the reference data when the part of the obtained biometric data is determined to correspond to the reference data.

2. The biometric data recording method according to claim 1, wherein
the recording the biometric data records, when the part of the obtained biometric data is determined to correspond to the reference data, a data portion of the obtained biometric data in association with the subject that is associated with the reference data, wherein the data portion is a data portion before the determining.

3. The biometric data recording method according to claim 2, wherein
the obtained biometric data includes a data portion of a first period, which is the data portion before the determining, and a data portion of a second period, which is a part of the obtained biometric data, and
the recording the obtained biometric data records the obtained biometric data including the data portion of the first period and the data portion of the second period in association with the subject when the data portion of the first period is determined to not correspond to the reference data and the data portion of the second period is determined to correspond to the reference data.

4. The biometric data recording method according to claim 1, wherein
the memory further stores reference auxiliary data in association with the subject, and
the determining whether or not the part of the obtained biometric data corresponds to the reference data determines whether or not auxiliary data detected by an auxiliary sensor corresponds to the reference auxiliary data stored in the memory when a difference between the part of the obtained biometric data and the reference data is greater than a first threshold and the difference is smaller than a second threshold, which is greater than the first threshold, and determines the part of the obtained biometric data to correspond to the reference data when the auxiliary data is determined to correspond to the reference auxiliary data.

5. The biometric data recording method according to claim 4, further comprising
registering the part of the obtained biometric data in the memory in association with another subject that is different from the subject when the difference is greater than the second threshold or when the auxiliary data is determined to not correspond to the reference auxiliary data.

6. The biometric data recording method according to claim 1, wherein
the biometric data is electrocardiogram data.

7. A biometric data recording device comprising:
a first memory that stores reference data in association with a subject;
a second memory; and
a processor that obtains time-series biometric data detected by a sensor, determines whether or not a part of the obtained biometric data corresponds to the reference data stored in the first memory, and records, in the second memory, the obtained biometric data in association with the subject that is associated with the reference data when the part of the obtained biometric data is determined to correspond to the reference data.

8. The biometric data recording device according to claim 7, wherein
the processor records, when the part of the obtained biometric data is determined to correspond to the reference data, a data portion of the obtained biometric data in association with the subject that is associated with the reference data, wherein the data portion is a data portion before whether or not the part of the obtained biometric data corresponds to the reference data is determined.

9. The biometric data recording device according to claim 8, wherein
the obtained biometric data includes a data portion of a first period, which is the data portion before whether or not the part of the obtained biometric data corresponds to the reference data is determined, and a data portion of a second period, which is a part of the obtained biometric data, and
the processor records, in the second memory, the biometric data including the data portion of the first period and the data portion of the second period in association with the subject when the data portion of the first period is determined to not correspond to the reference data and the data portion of the second period is determined to correspond to the reference data.

10. The biometric data recording device according to claim 7, wherein
the first memory further stores reference auxiliary data in association with the subject, and
the processor determines whether or not auxiliary data detected by an auxiliary sensor corresponds to the reference auxiliary data stored in the first memory when a difference between the part of the obtained biometric data and the reference data is greater than a first threshold and the difference is smaller than a second threshold, which is greater than the first threshold, and determines the part of the obtained biometric data to correspond to the reference data when the auxiliary data is determined to correspond to the reference auxiliary data.

11. The biometric data recording device according to claim 10, wherein
the processor registers the part of the obtained biometric data in the first memory in association with another subject that is different from the subject when the difference is greater than the second threshold or when the auxiliary data is determined to not correspond to the reference auxiliary data.

12. The biometric data recording device according to claim 7, wherein
the biometric data is electrocardiogram data.

13. A non-transitory computer-readable recording medium having stored therein a biometric data recording program that causes a computer to execute a process comprising:
obtaining time-series biometric data detected by a sensor;
determining whether or not a part of the obtained biometric data corresponds to reference data stored in a memory by referring to the memory storing the reference data in association with a subject; and
recording the obtained biometric data in association with the subject that is associated with the reference data when the part of the obtained biometric data is determined to correspond to the reference data.

14. The non-transitory computer-readable recording medium according to claim 13, wherein
the recording the biometric data records, when the part of the obtained biometric data is determined to correspond to the reference data, a data portion of the obtained biometric data in association with the subject that is associated with the reference data, wherein the data portion is a data portion before the determining.

15. The non-transitory computer-readable recording medium according to claim 14, wherein
the obtained biometric data includes a data portion of a first period, which is the data portion before the determining, and a data portion of a second period, which is a part of the obtained biometric data, and
the recording the biometric data records the biometric data including the data portion of the first period and the data portion of the second period in association with the subject when the data portion of the first period is determined to not correspond to the reference data and the data portion of the second period is determined to correspond to the reference data.

16. The non-transitory computer-readable recording medium according to claim 13, wherein
the memory further stores reference auxiliary data in association with the subject, and
the determination whether or not the part of the obtained biometric data corresponds to the reference data determines whether or not auxiliary data detected by an auxiliary sensor corresponds to the reference auxiliary data stored in the memory when a difference between the part of the obtained biometric data and the reference data is greater than a first threshold and the difference is smaller than a second threshold, which is greater than the first threshold, and determines the part of the obtained biometric data to correspond to the reference data when the auxiliary data is determined to correspond to the reference auxiliary data.

17. The non-transitory computer-readable recording medium according to claim 16, wherein
the process further comprises registering, in the memory, the part of the obtained biometric data in association with another subject that is different from the subject when the difference is greater than the second threshold or when the auxiliary data is determined to not correspond to the reference auxiliary data.

18. The non-transitory computer-readable recording medium according to claim 13, wherein
the biometric data is electrocardiogram data.
